(19) United States
(12) Patent Application Publication
(10) Pub. No.: US 2018/0217562 A1
(43) Pub. Date: Aug. 2, 2018

(54) INTUITIVE DISPLAY OF TIME NOTIFICATIONS IN MOBILE DEVICES

(71) Applicant: QUALCOMM Incorporated, San Diego, CA (US)

(72) Inventors: Syam Pavan VADAPALLI, Visakhapatnam (IN); AnkammaRao RAVUVARI, Hyderabad (IN)

(21) Appl. No.: 15/423,332

(22) Filed: Feb. 2, 2017

(51) Int. Cl. G04G 11/00; G04G 9/00; G04F 1/00

(52) U.S. Cl. CPC G04G 11/00; G04F 1/005; G04G 9/00

(57) ABSTRACT

Display of the time remaining to the next scheduled alarm at the status bar on the display screen of the mobile device, may be helpful to the user to plan ahead for the event the alarm is set for. In an aspect of the disclosure, a method, a computer-readable medium, and an apparatus are provided. The apparatus may be a user equipment including a display, at least one processor and a memory coupled to the at least one processor. The processor determines one or more existing alarms in the mobile device, and a corresponding alarm set time for each existing alarm of the one or more existing alarms. The processor determines a time remaining to a next existing alarm of the one or more existing alarms. The processor configures a display screen status bar to show on the status bar, the determined time remaining to the next existing alarm.

### FIELD

The present disclosure relates generally to mobile devices, and more particularly, to an intuitive display of time notifications in mobile devices.

### BACKGROUND

In currently available mobile devices in the market, when a user of a mobile device (e.g., smartphone) sets an alarm, the notification or status bar on the display screen of the mobile device displays an alarm icon until the alarm is cleared. However, in currently available mobile devices, the time remaining to the next scheduled alarm is not displayed on the status bar on the display screen of the mobile device. In situations where the mobile device user sets an alarm for a time occurring in a distant future (e.g., the alarm set time is few days or weeks from the day the alarm is set), the currently available technology which displays only the alarm icon on the display screen status bar of the mobile device, may not be very useful. Further, with currently available mobile devices in the market, when a user of the mobile device starts a stop watch or a timer in the mobile device, the time lapsed in the stop watch or the time remaining of the timer is not visible on the status bar of the mobile device. Therefore, when the display screen of the mobile device is in a locked position or when a user is working with one or more applications other than the stop watch or the timer, the user needs to switch to the stop watch or the timer application to determine how much time has lapsed since the stop watch function was started or how much time is remaining since the timer was started on the mobile device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Current mobile devices do not display a time remaining to a next existing alarm of the one or more existing alarms in the mobile device. In situations where the mobile device user sets an alarm for a time that occurs in the future (e.g., the alarm set time is few days or weeks from when the alarm is set), the currently available technology which displays only the alarm icon in the status bar without any notification of the time remaining to the next scheduled alarm, may not be very useful. In such situations, display of more information (e.g., the time remaining to the next existing alarm) on the display screen status bar of the mobile device regarding the next existing alarm may help the user plan ahead for the event associated with the alarm. Additionally, the display of the time remaining to the next existing alarm on the display screen status bar of the mobile device may help the user determine if an error has been made when setting the alarm (e.g., the alarm is set at 7 pm instead of 7 am).

Current mobile devices also do not display an elapsed time in a stop watch or a time remaining of a timer running on a mobile device. Therefore, when the display screen of the mobile device is in a locked position or when a user is working on one or more applications other than the stop watch or the timer application, the user needs to switch application screens to determine how much time has elapsed in the stop watch since the stop watch was started or how much time is remaining since the timer was started. In such situations, display of more information (e.g., the stop watch elapsed time or time remaining of the timer) on the display screen status bar of the mobile device may help the user keep track of the elapsed time or the time remaining.

Therefore, there is a need for an informative display of time notification (e.g., time remaining to the next existing alarm and elapsed time in the stop watch or the time remaining of the timer) on the display screen status bar of the current mobile devices.

In an aspect of the disclosure, a method, a computer-readable medium, and an apparatus are provided. The apparatus may be a user equipment including a display, at least one processor and a memory coupled to the at least one processor. The processor determines one or more existing alarms in a mobile device, and a corresponding alarm set time for each existing alarm of the one or more existing alarms. The processor determines a time remaining to a next existing alarm of the one or more existing alarms. The processor configures a display screen status bar to show on the status bar, the determined time remaining to the next existing alarm.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example of a mobile device.

FIG. 2A illustrates a mobile device according to an aspect.

FIG. 2B illustrates the mobile device of FIG. 2A, according to another aspect.

FIG. 2C illustrates the mobile device of FIG. 2A, according to a further aspect.

FIG. 3 illustrates a flowchart of a method to display the time remaining to the next existing alarm at the status bar on the display screen of the mobile device of FIGS. 2A-2C when a user of the mobile device sets an alarm.

FIG. 4A is a flowchart of a method of providing an elapsed time of a stop watch running on a mobile device, according to an aspect.

FIG. 4B is a flowchart of a method of providing a time remaining of a timer running on a mobile device, according to an aspect.

FIG. 5 is a conceptual data flow diagram illustrating the data flow between different means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of mobile devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

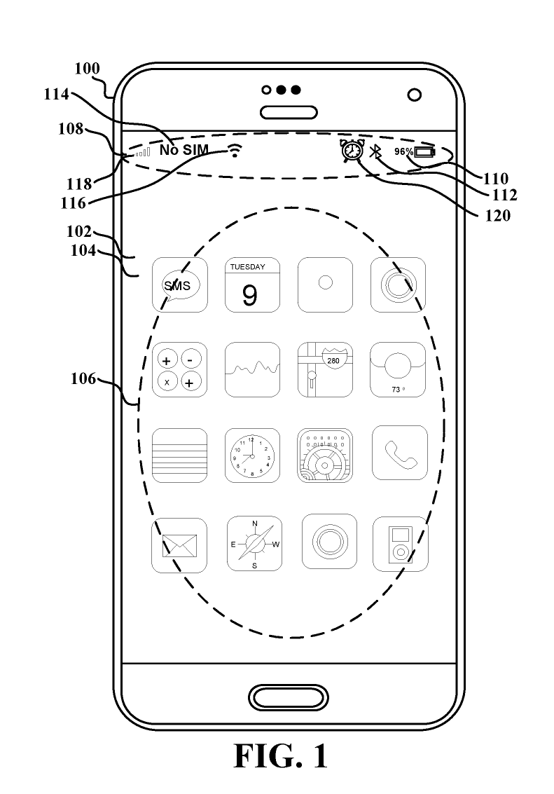

FIG. 1 illustrates a mobile device 100. The mobile device 100 may be a smart phone, a smart watch, a virtual reality device, a tablet, a laptop computer, or the like. The mobile device 100 may include a display screen 102 (e.g., a liquid crystal display (LCD), a light emitting diode (LED) array) in a first surface 104 of the mobile device 100. A second surface (not shown) of the mobile device 100 may be covered with a cover made of plastic, glass, metal, or the like. The display screen 102 may display a plurality of application icons 106 corresponding to a plurality of applications stored in the mobile device 100. The display screen 102 may also display a notification or status bar 108. The status bar 108 on the display screen 102 may display a plurality of icons representing, for example, an icon 110 showing an amount of charge left in the battery of the mobile device 100, an icon 112 showing whether Bluetooth is turned on in the mobile device 100, an icon 114 showing whether the mobile device 100 has a subscriber identity module (SIM) installed in the mobile device 100, an icon 116 showing if the mobile device 100 is connected to a Wi-Fi service, an icon 118 showing the connectivity of the mobile device 100 with a cellular mobile network (e.g., LTE), or the like. In situations, when a user of the mobile device 100 sets one or more alarms, the status bar 108 on the display screen 102 of the mobile device 100 may display an alarm icon 120 until all existing alarms are cleared.

In mobile device 100, the time remaining to a scheduled alarm is not displayed in the status bar 108 on the display screen 102 of the mobile device 100. In situations where the user of the mobile device 100 sets an alarm occurring in the future (e.g., the alarm set time is few days or weeks from when the alarm is set), displaying only the alarm icon 120 in the status bar 108 without any notification of the time remaining to the scheduled alarm, may not be very useful. In such situations, display of more information (e.g., the time remaining to the scheduled alarm) on the status bar 108 on the display screen 102 of the mobile device 100 regarding the scheduled alarm may help the user of the mobile device 100 plan ahead for the event associated with the alarm. Additionally, the display of the time remaining to the scheduled alarm on the status bar 108 of the display screen 102 of the mobile device 100 may help the user of the mobile device 100 to determine if an error was made when setting the alarm (e.g., the alarm is set at 7 pm instead of 7 am).

Further, when a user of the mobile device 100 starts a stop watch or a timer on the mobile device 100, the elapsed time since starting the stop watch or the time remaining since the starting of the timer of the mobile device 100 is not visible at the status bar 108 of the mobile device 100. Therefore, when the display screen 102 of the mobile device 100 is in a locked position or when a user of the mobile device 100 is working with one or more application icons 106 other than the stop watch or the timer, the user needs to switch to the stop watch or the timer application screen to determine how much time has elapsed since starting the stop watch or how much time is remaining since starting the time. In such situations, display of more information (e.g., the elapsed time of the stop watch or time remaining of the timer) on the status bar 108 on the display screen 102 of the mobile device 100 may help the user keep track of the elapsed time or the time remaining.

Therefore, there is a need for an informative display of alarm information (e.g., time remaining to the next existing alarm and elapsed time in the stop watch or the time remaining of the timer) on the status bar on the display screen of mobile devices.

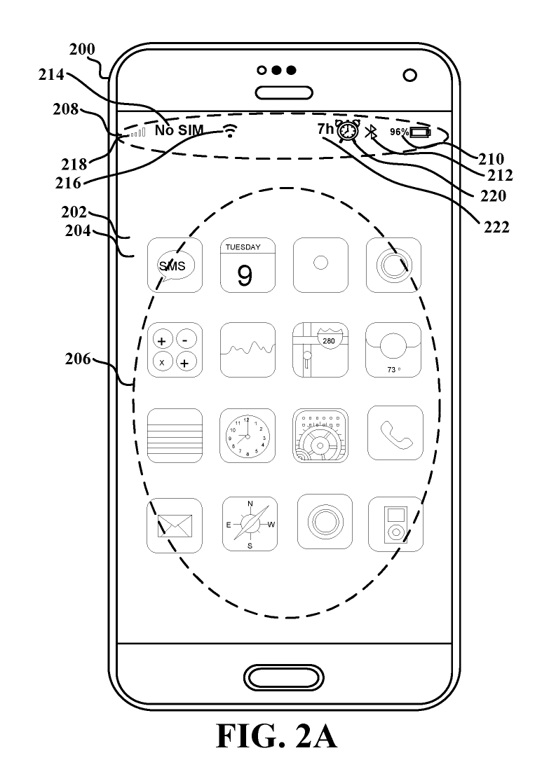

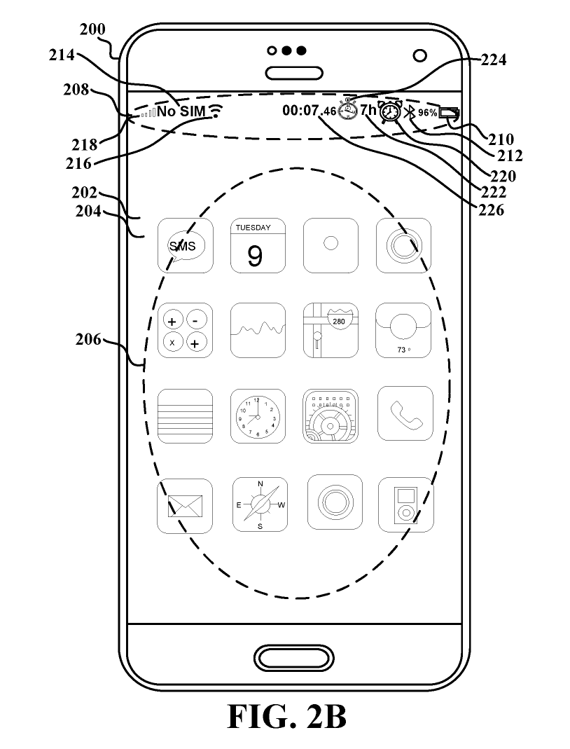

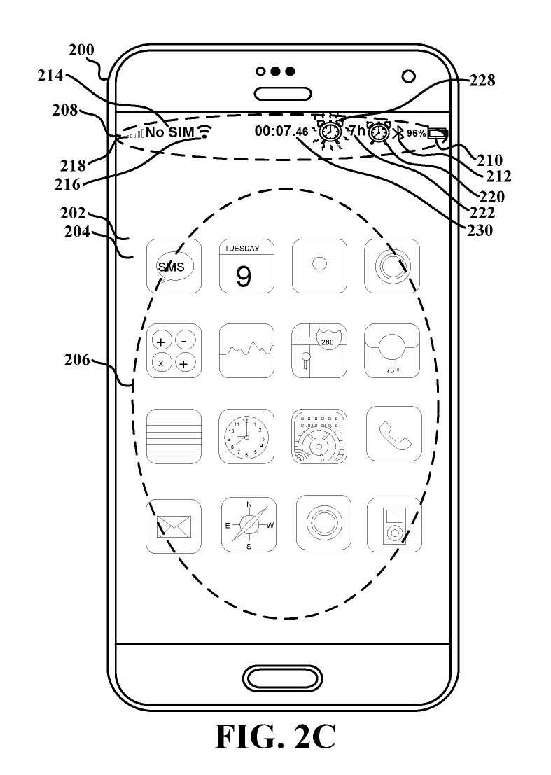

FIG. 2A illustrates a mobile device 200 according to an aspect. The mobile device 200 may be a smart phone, a smart watch, a virtual reality device, a tablet, etc. The mobile device 200 may include a display screen 202 (e.g., liquid crystal display (LCD), light emitting diode (LED) display, etc.) in a first surface 204 of the mobile device 200. A second surface (not shown) of the mobile device 200 may be covered with a cover made of plastic, glass, metal, or the like. The display screen 202 may display a plurality of icons 206 corresponding to a plurality of applications stored in the mobile device 200. The display screen 202 may also display a notification or status bar 208. The status bar 208 on the display screen 202 may display a plurality of icons representing, for example, an icon 210 showing an amount of charge left in the battery of the mobile device 200, an icon 212 showing whether Bluetooth is on in the mobile device 200, an icon 214 showing whether the mobile device 200 has a subscriber identity module (SIM) installed in the mobile device 200, an icon 216 showing if the mobile device 200 is connected to a Wi-Fi service, an icon 218 showing if the mobile device 200 is connected to a cellular mobile network (e.g., LTE), or the like. The status bar 208 of the mobile device 200 may also display an alarm icon 220 when an alarm is set on the mobile device 200. The status bar 208 may display the alarm icon 220 until the alarm is cleared.

In an aspect, the status bar 208 of the mobile device 200 may also display the time remaining 222 to the next existing alarm set on the mobile device 200. In the exemplary configurations of the present disclosure, a next existing alarm may be defined as the alarm scheduled to occur next after the present time. The status bar 208 may continuously or periodically display the time remaining 222 to the next existing alarm adjacent to the alarm icon 220 until the alarm is cleared. The resolution of the displayed time may be in days, hours, minutes or a combination. If the time remaining 222 to the next existing alarm is less than twenty four hours and greater than or equal to one hour, the time remaining 222 to the next existing alarm may be displayed in increments of hours on the status bar 208 on the display screen 202 of the mobile device 200. If the time remaining 222 to the next existing alarm is less than an hour, the status bar 208 on the display screen 202 of the mobile device 200 may display the time remaining 222 to the next existing alarm in increments of minutes. If the time remaining 222 to the next existing alarm is less than a minute, the status bar 208 on the display screen 202 of the mobile device 200 may display the time remaining 222 to the next existing alarm in increments of seconds.

In an aspect, if the mobile device 200 changes to new time zone, the time remaining to each of the existing alarms of the one or more existing alarms is updated based on the new time zone. In another aspect, a priority level for each existing alarm of the one or more existing alarms may be received at the mobile device 200. In such case, the processor embedded in the mobile device may determine a highest priority alarm of the one or more existing alarms. In an aspect, the time remaining 222 to the next existing alarm is the time remaining to the highest priority alarm of the one or more existing alarms. In an aspect, one or more time zones corresponding to one or more alarm set time for the one or more existing alarms may be received at the mobile device. In such case, the mobile device 200 may set the one or more existing alarms based on the one or more alarm set time and the one or more time zones. The time remaining 222 to the next existing alarm may be displayed adjacent to the alarm icon 220 in the status bar 208 of the display screen 202 of the mobile device 200. The feature of showing the time remaining 222 to the next existing alarm at the status bar 208 of the mobile device 200 may be enabled or disabled via the settings of the mobile device 200.

FIG. 2B illustrates the mobile device 200, according to another aspect. As shown in FIG. 2B, the status bar 208 of the mobile device 200 may also display a stop watch or a timer icon 224 when a stop watch or a timer is started (activated) on the mobile device 200. The status bar 208 may display the stop watch or the timer icon 224 until the stop watch is stopped or the timer counted down to zero. The status bar 208 of the mobile device 200 may display the elapsed time 226 of the running stop watch or the time remaining 226 of the running timer of the mobile device 200. The status bar 208 may display the elapsed time 226 of the running stop watch or the time remaining 226 of the running timer of the mobile device adjacent to the stop watch or the timer icon 224 until the stop watch or the timer of the mobile device 200 is stopped or counted down to zero. The displayed time resolution of the elapsed time may be in increments of days, hours, minutes and/or seconds. The displayed time resolution of the time remaining may be in decrements of days, hours, minutes and/or seconds. The display of the stop watch or the timer icon 224 and the elapsed time 226 of the stop watch or the time remaining 226 of the timer running in the mobile device 200 may be enabled or disabled via the settings of the mobile device 200. Displaying the stop watch or the timer icon 224 and the elapsed time 226 of the running stop watch or the time remaining 226 of the running timer of the mobile device 200 on the status bar 208 of the display screen 202 of the mobile device 200 may enhance user experience, since the user does not need to open the stop watch or the timer application to verify whether there is an error in turning on the stop watch or the timer or how much time has elapsed since the stop watch was started or how much time is remaining since the timer has started. In an aspect, the time the stop watch is started may be stored and the elapsed time 226 may be determined by subtracting the start time from the current time to determine the elapsed time 226. The elapsed time may be determined periodically, e.g., every one second. Alternatively, a counter may be initialized to zero when the stop watch is started and incremented every second.

FIG. 2C illustrates the mobile device 200, according to a further aspect. As shown in FIG. 2C, the status bar 208 of the mobile device 200 may also display a snooze alarm icon 228 when the snooze alarm option in the mobile device 200 is turned on (activated). The status bar 208 may display the snooze alarm icon 228 until the snooze alarm running in the mobile device 200 is cleared. The status bar 208 of the mobile device 200 may also display the time remaining 230 to the next snooze alarm when the snooze alarm option in the mobile device 200 is turned on after an alarm indication (e.g., alarm sound) is provided for an existing alarm. The status bar 208 may display the time remaining 230 to the next snooze alarm adjacent to the snooze alarm icon 228 until the snooze alarm running in the mobile device 200 is cleared. The displayed time remaining may have a resolution of minutes and/or seconds. The feature of showing the snooze alarm icon 228 and the time remaining 230 to the next snooze alarm may be enabled or disabled via the settings function of the mobile device 200. Displaying the snooze alarm icon 228 and the time remaining 230 to the next snooze alarm on the status bar 208 of the display screen 202 of the mobile device 200 may enhance user experience, since the user does not need to open the alarm application to verify whether there is an error in turning on the snooze alarm or see how much time is left before the next snooze alarm.

In an aspect, the status bar 208 may display either the time remaining 222 to the next existing alarm or the time remaining 230 to the next snooze alarm. In such case, if there is an existing alarm that is set between an alarm set at current time and the next snooze time of the alarm set at current time, the status bar 208 may display the time remaining to the existing alarm, until that alarm clears. Once the existing alarm that is set between the alarm set at current time and the next snooze time of the alarm set at current time clears, the status bar 208 may display the time remaining 230 to the next snooze of the alarm set at current time. In another configuration, the status bar 208 may display the time remaining 222 to the next existing alarm in a color (e.g., red) different from the color (e.g., green) the time remaining 230 to the next snooze alarm is displayed on the status bar 208.

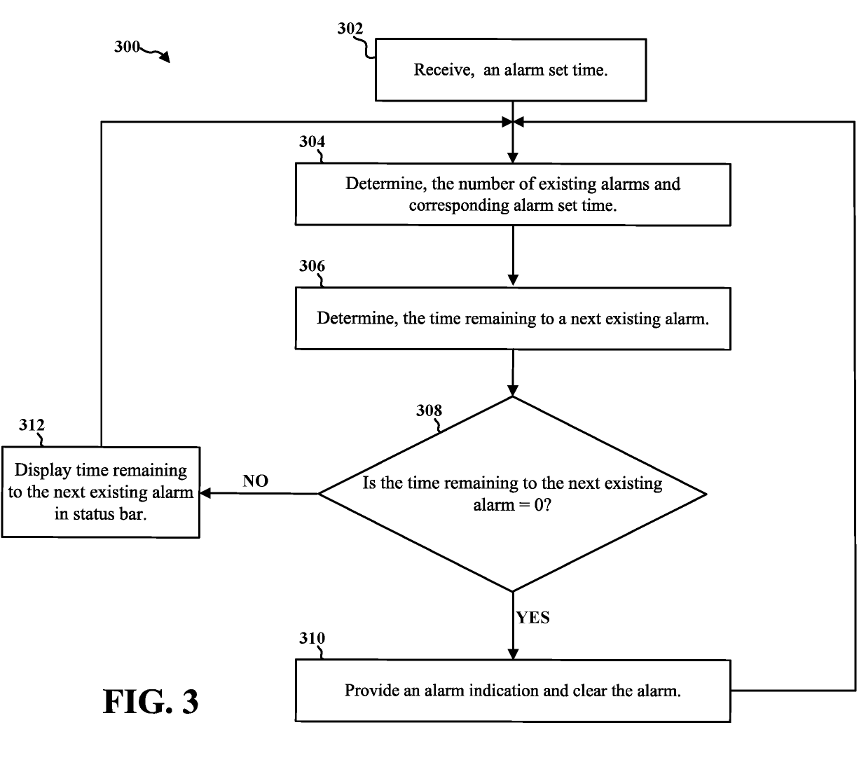

FIG. 3 illustrates a flowchart 300 of a method to display the time remaining 222 to the next existing alarm on the status bar 208 on the display screen 202 of the mobile device 200 when an alarm is set. At 302, a processor embedded in the mobile device 200 receives an alarm set time for an alarm set on the mobile device 200. At 304, the processor determines the total number of one or more existing alarms and a corresponding alarm set time for each alarm of the one or more existing alarms set on the mobile device 200. At 306, the processor determines a time remaining 222 to a next existing alarm of the one or more existing alarms. Next, at 308, the processor determines if the time remaining 222 to the next existing alarm of the one or more existing alarms is equal to zero. If so, at 310 the processor provides an alarm indication (e.g., alarm sound) for an existing alarm of the one or more existing alarms and clears the alarm for which the alarm indication is provided. However, if at 308, the processor determines that the time remaining 222 to the next existing alarm of the one or more existing alarms is not equal to zero, at 312, the processor displays an alarm icon 220 and the time remaining 222 to the next existing alarm of the one or more existing alarms on the status bar 208 on the display screen 202 of the mobile device 200. Method 300 may also be used to display the snooze alarm icon 228 and/or the time remaining 230 to the next snooze alarm on the status bar 208 of the display screen 202 of the mobile device 200.

In one configuration, the processor may determine the time remaining 222 to the next existing alarm by calculating a time difference between a current time and the corresponding alarm set time of the next existing alarm. In another configuration, if the time remaining 222 to the next existing alarm is determined to be greater than twenty four hours, the time remaining to the next existing alarm is displayed in increments of days and/or fraction of days on the status bar 208 of the display screen 202 of the mobile device 200. In yet another configuration, if the time remaining 222 to the next existing alarm is determined to be less than twenty four hours and greater than or equal to one hour, the time remaining 222 to the next existing alarm is displayed in increments of hours on the status bar 208 of the display screen 202 of the mobile device 200. In a further configuration, if the time remaining 222 to the next existing alarm is determined to be less than an hour, the time remaining 222 to the next existing alarm is displayed in increments of minutes on the status bar 208 of the display screen 202 of the mobile device 200.

In an aspect, if the mobile device 200 changes to new time zone, the time remaining to each of the existing alarms of the one or more existing alarms is updated based on the new time zone. In another aspect, the mobile device 200 may receive a priority level for each existing alarm of the one or more existing alarms. In an aspect, the processor embedded in the mobile device 200 may determine a highest priority alarm of the one or more existing alarms. In a configuration, the time remaining to a next existing alarm is the time remaining to the highest priority alarm of the one or more existing alarms. In another configuration, the mobile device 200 may receive one or more time zones corresponding to one or more alarm set time for the one or more existing alarms. In a further configuration, the one or more existing alarms are set in the mobile device 200 based on the one or more alarm set time and the one or more time zones. In an aspect, the next existing alarm is a snooze alarm and the time remaining 222 to the next existing alarm of the one or more existing alarms is the time remaining to a next snooze.

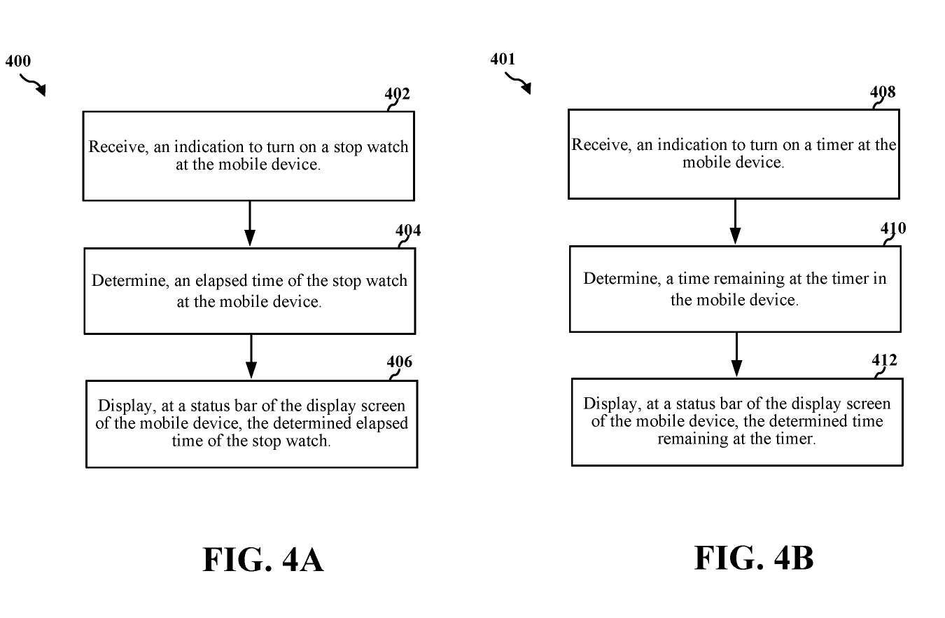

FIG. 4A is a flowchart 400 of a method of providing an elapsed time for a stop watch running on a mobile device, according to an aspect. The method may be performed by a processor. In one configuration, the flowchart 400 described in FIG. 4A may be the performed by the mobile device described above with reference to FIG. 2B.

In an aspect, at 402, the mobile device may receive an indication to turn on a stop watch at a mobile device. For example, the mobile device 200 may receive an indication to turn on a stop watch at the mobile device 200. At 404, the processor may determine an elapsed time of the stop watch running on the mobile device once the stop watch is started. For example, the processor embedded in the mobile device 200 may determine an elapsed time 226 of the stop watch running on the mobile device 200 once the stop watch is started. In an aspect, the time the stop watch is started may be stored and the elapsed time may be determined by subtracting the start time from the current time to determine the elapsed time. The elapsed time may be determined periodically, e.g., every one second. Alternatively, a counter may be initialized to zero when the stoop watch is started and incremented every second. At 406, the determined elapsed time of the stop watch running on the mobile device may be displayed on the status bar of the display screen of the mobile device. For example, the determined elapsed time 226 of the stop watch running on the mobile device 200 may be displayed on the status bar 208 of the display screen 202 of the mobile device 200. The resolution of the elapsed time 226 may be displayed in increments of seconds, minutes, etc.

FIG. 4B is a flowchart 401 of a method of providing a time remaining of a timer running on a mobile device, according to an aspect. The method may be performed by a processor. In one configuration, the flowchart 401 described in FIG. 4B may be the performed by the mobile device described above with reference to FIG. 2B.

In an aspect, at 408, the mobile device may receive an indication to turn on a timer at a mobile device. For example, the mobile device 200 may receive an indication to turn on a timer at the mobile device 200. At 410, the processor may determine a time remaining at the timer running on the mobile device once the timer is started. For example, the processor embedded in the mobile device 200 may determine a time remaining 226 at the timer running on the mobile device 200 once the timer is started. At 412, the determined time remaining at the timer running on the mobile device may be displayed on the status bar of the display screen of the mobile device. For example, the determined time remaining 226 at the timer running on the mobile device 200 may be displayed on the status bar 208 of the display screen 202 of the mobile device 200. The resolution of the time remaining 226 may be displayed in decrements of days, hours, minutes, seconds etc.

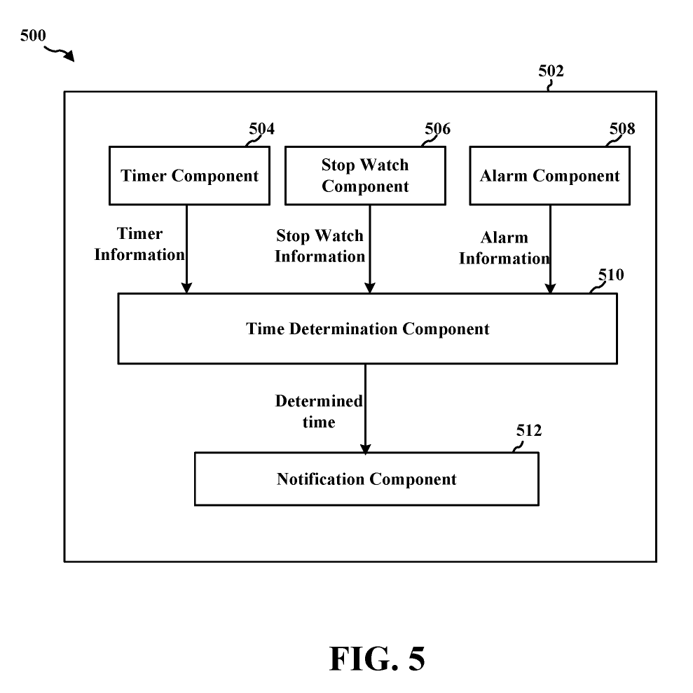

FIG. 5 is a conceptual data flow diagram 500 illustrating the data flow between different means/components in an exemplary apparatus 502. The apparatus may be a user equipment including a display, at least one processor and a memory coupled to the at least one processor.

In an aspect, the apparatus 502 may include a timer component 504, a stop watch component 506 and an alarm component 508. The timer component 504 may receive an indication to turn on a timer at the apparatus 502. The stop watch component 506 may receive an indication to turn on a stop watch at the apparatus 502. The alarm component 508 may receive one or more alarms and a corresponding alarm set time for each alarm of the one or more alarms. The apparatus 502 may also include a time determination component 510 that determines a time remaining to a next existing alarm of the one or more existing alarms at the alarm component 508. The time determination component 510 may also determines an elapsed time at the stop watch component 506 and a time remaining at the timer component 504. The apparatus 502 may further include a notification component 512 to display at a status bar (e.g., 208) of a display screen of the apparatus 502, the determined time remaining (e.g., 222) to the next existing alarm, an elapsed time at the stop watch component 506 and a time remaining at the timer component 504.

In one configuration, the notification component 512 may provide an alarm indication when the time remaining (e.g., 222) to the next existing alarm is determined to be zero. The notification component 512 may clear the next existing alarm of the one or more existing alarms, after the alarm indication is provided for the next existing alarm. In an aspect, the time remaining to the next existing alarm may be determined by calculating a time difference between a current time and the corresponding alarm set time of the next existing alarm.

In one configuration, if the time remaining (e.g., 222) to the next existing alarm is determined to be greater than twenty four hours, the time remaining (e.g., 222) to the next existing alarm is displayed in increments of days and/or fraction of days on the status bar (e.g., 208) of the display screen (e.g., 202) of the apparatus 502. In another configuration, if the time remaining (e.g., 222) to the next existing alarm is determined to be less than twenty four hours and greater than or equal to one hour, the time remaining to the next existing alarm is displayed in increments of hours on the status bar (e.g., 208) of the display screen (e.g., 202) of the apparatus 502. In an aspect, if the time remaining (e.g., 222) to the next existing alarm is determined to be less than an hour, the time remaining (e.g., 222) to the next existing alarm is displayed in increments of minutes on the status bar (e.g., 208) of the display screen (e.g., 202) of the apparatus 502. In a configuration, if the apparatus 502 changes to new time zone, the time remaining (e.g., 222) to each of the existing alarms of the one or more existing alarms is updated based on the new time zone.

In another configuration, the Alarm component 508 may receive a priority level for each existing alarm of the one or more existing alarms. The time determination component 510 may determine the highest priority alarm of the one or more existing alarms. In an aspect, the time remaining to a next existing alarm (e.g., 222) is the time remaining to the highest priority alarm of the one or more existing alarms.

In an aspect, the alarm component 508 may receive one or more time zones corresponding to one or more alarm set time for the one or more existing alarms (e.g., a GPS receiver that determines the current time and time zone). In a further configuration, the one or more existing alarms are set in the apparatus 502 based on the one or more alarm set time and the one or more time zones. In one configuration, the alarm is a snooze alarm and the time remaining (e.g., 222) to a next existing alarm of the one or more existing alarms is the time remaining to a next snooze.

In another configuration, the status bar (e.g., 208) may display the time remaining (e.g., 222) to the next existing alarm in a color (e.g., red) different from the color (e.g., green) the time remaining (e.g., 230) to the next snooze alarm is displayed on the status bar (e.g., 208) of the apparatus 502.

The apparatus 502 may include additional components that perform each of the blocks of the algorithm in the aforementioned flowcharts of FIGS. 3, 4A, 4B. As such, each block in the aforementioned flowcharts of FIGS. 3, 4A, 4B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

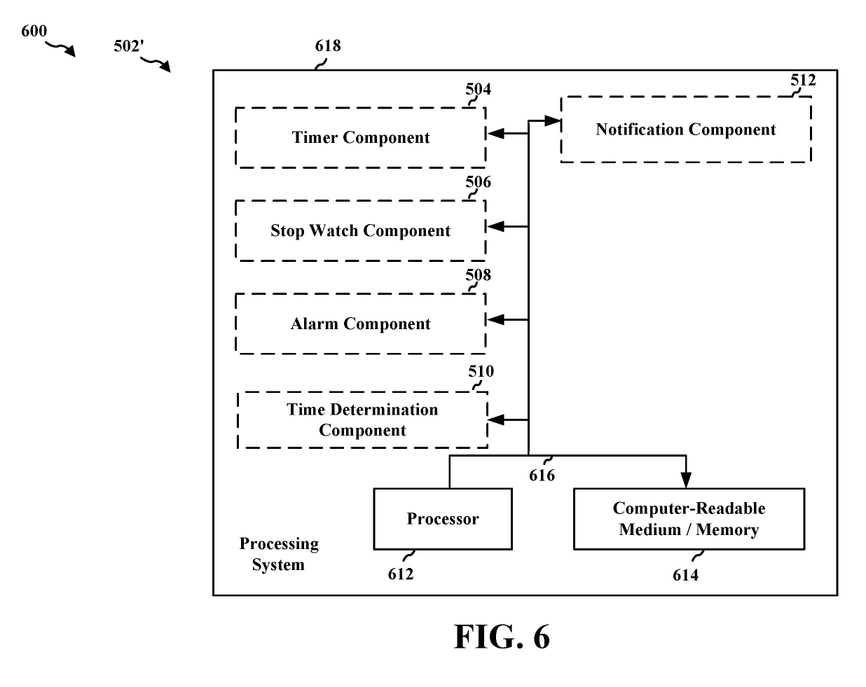

FIG. 6 is a diagram 600 illustrating an example of a hardware implementation for an apparatus 502′ employing a processing system 618. The processing system 618 may be implemented with a bus architecture, represented generally by the bus 616. The bus 616 may include any number of interconnecting buses and bridges depending on the specific application of the processing system 618 and the overall design constraints. The bus 616 links together various circuits including one or more processors and/or hardware components, represented by the processor 612, the timer component 504, the stop watch component 506, the alarm component 508, the time determination component 510, the notification component 512, and the computer-readable medium/memory 614. The bus 616 may also link various other circuits such as timing sources, peripherals, voltage regulators, and power management circuits, which are well known in the art, and therefore, will not be described any further.

The processor 612 is responsible for general processing, including the execution of software stored on the computer-readable medium/memory 614. The software, when executed by the processor 612, causes the processing system 618 to perform the various functions described supra for any particular apparatus. The computer-readable medium/memory 614 may also be used for storing data that is manipulated by the processor 612 when executing software. The processing system 618 further includes at least one of the components, the timer component 504, the stop watch component 506, the alarm component 508, the time determination component 510, and the notification component 512. The components may be software components running in the processor 612, resident/stored in the computer readable medium/memory 614, one or more hardware components coupled to the processor 612, or some combination thereof.

In some configurations, methods shown in FIGS. 3, 4A, and 4B may be performed by the hardware shown in FIGS. 5 and 6.

In one configuration, the apparatus 502/502′ for wireless communication includes means for determining one or more existing alarms in a mobile device, and a corresponding alarm set time for each existing alarm of the one or more existing alarms. The apparatus 502/502′ for wireless communication also includes means for determining a time remaining to a next existing alarm of the one or more existing alarms. Further, the apparatus 502/502′ for wireless communication includes means for displaying at a status bar of a display screen of the mobile device, the determined time remaining to the next existing alarm. Moreover, the apparatus 502/502′ for wireless communication includes means for providing, an alarm indication, when the time remaining to the next existing alarm is determined to be zero. Additionally, the apparatus 502/502′ for wireless communication includes means for clearing, the next existing alarm of the one or more existing alarms, after the alarm indication is provided for the next existing alarm. The apparatus 502/502′ for wireless communication also includes means for receiving a priority level for each existing alarm of the one or more existing alarms. Further, the apparatus 502/502′ for wireless communication includes means for determining a highest priority alarm of the one or more existing alarms.

Moreover, the apparatus 502/502′ for wireless communication includes means for receiving one or more time zones corresponding to one or more alarm set time for the one or more existing alarms. In one configuration, setting the one or more existing alarms includes setting the one or more existing alarms based on the one or more alarm set time and the one or more time zones. Additionally, the apparatus 502/502′ for wireless communication includes means for receiving a snooze alarm, means for determining a time remaining to the snooze alarm, and means for displaying, on the status bar of the display screen, the determined time remaining to the snooze alarm in a first color different from a second color for displaying the determined time remaining to the next existing alarm. Further, the apparatus 502/502′ for wireless communication further includes means for receiving an indication to turn on a stop watch or a timer of the mobile device, means for determining an elapsed time of the stop watch or a time remaining of the timer at the mobile device, and the means for displaying at the status bar of the display screen of the mobile device, the determined elapsed time at the stop watch or the time remaining of the timer. Also, the apparatus 502/502′ for wireless communication includes means for receiving, an alarm set time for an alarm at the mobile device, means for setting the alarm to the alarm set time.

The aforementioned means may be one or more of the aforementioned components of the apparatus 502/502′ and/or the processing system 618 of the apparatus 502/502″ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of providing an alarm indicator, comprising:
determining, by a processor embedded in a mobile device, one or more existing alarms in the mobile device, and a corresponding alarm set time for each existing alarm of the one or more existing alarms;
determining, by the processor, a time remaining to a next existing alarm of the one or more existing alarms; and
displaying, on a status bar of a display screen of the mobile device, the determined time remaining to the next existing alarm.

2. The method of claim 1 further comprising:
providing, an alarm indication, when the time remaining to the next existing alarm is determined to be zero by the processor; and
clearing, the next existing alarm of the one or more existing alarms, after the alarm indication is provided for the next existing alarm.

3. The method of claim 1, wherein the processor determines the time remaining to the next existing alarm by calculating a time difference between a current time and the corresponding alarm set time of the next existing alarm.

4. The method of claim 1, wherein if the time remaining to the next existing alarm is determined to be greater than twenty four hours, the time remaining to the next existing alarm is displayed in increments of days and/or fraction of days on the status bar of the display screen of the mobile device.

5. The method of claim 1, wherein if the time remaining to the next existing alarm is determined to be less than twenty four hours and greater than or equal to one hour, the time remaining to the next existing alarm is displayed in increments of hours on the status bar of the display screen of the mobile device.

6. The method of claim 1, wherein if the time remaining to the next existing alarm is determined to be less than an hour, the time remaining to the next existing alarm is displayed in increments of minutes on the status bar of the display screen of the mobile device.

7. The method of claim 1, wherein if the mobile device changes to new time zone, the time remaining to each of the existing alarms of the one or more existing alarms is updated based on the new time zone.

8. The method of claim 1 further comprising:
receiving, at the mobile device, a priority level for each existing alarm of the one or more existing alarms; and
determining, by the processor, a highest priority alarm of the one or more existing alarms.

9. The method of claim 8, wherein the time remaining to the next existing alarm is the time remaining to the highest priority alarm of the one or more existing alarms.

10. The method of claim 1 further comprising:
receiving, at the mobile device, one or more time zones corresponding to one or more alarm set time for the one or more existing alarms, wherein the setting the one or more existing alarms comprises setting the one or more existing alarms based on the one or more alarm set time and the one or more time zones.

11. The method of claim 1, wherein the next existing alarm is a snooze alarm and the time remaining to the next existing alarm of the one or more existing alarms is the time remaining to a next snooze.

12. The method of claim 1, further comprising:
receiving a snooze alarm;
determining a time remaining to the snooze alarm; and
displaying, on the status bar of the display screen, the determined time remaining to the snooze alarm in a first color different from a second color for displaying the determined time remaining to the next existing alarm.

13. The method of claim 1 further comprising:
receiving, at the mobile device, an indication to turn on a stop watch or a timer of the mobile device;
determining, by the processor, an elapsed time of the stop watch or a time remaining of the timer, at the mobile device; and
displaying, on the status bar of the display screen of the mobile device, the determined elapsed time of the stop watch or the time remaining of the timer.

14. The method of claim 1 further comprising:
receiving, by the processor, an alarm set time for an alarm at the mobile device;
setting the alarm to the alarm set time by the processor.

15. An apparatus for providing an alarm indicator, comprising:
means for determining one or more existing alarms in a mobile device, and a corresponding alarm set time for each existing alarm of the one or more existing alarms;
means for determining a time remaining to a next existing alarm of the one or more existing alarms; and
means for displaying at a status bar of a display screen of the mobile device, the determined time remaining to the next existing alarm.

16. The apparatus of claim 15 further comprising:
means for providing, an alarm indication, when the time remaining to the next existing alarm is determined to be zero; and
means for clearing, the next existing alarm of the one or more existing alarms, after the alarm indication is provided for the next existing alarm.

17. The apparatus of claim 15, wherein the means for determining determines the time remaining to the next existing alarm by calculating a time difference between a current time and the corresponding alarm set time of the next existing alarm.

18. The apparatus of claim 15, wherein if the time remaining to the next existing alarm is determined to be greater than twenty four hours, the time remaining to the next existing alarm is displayed in increments of days and/or fraction of days on the status bar of the display screen of the mobile device.

19. The apparatus of claim 15, wherein if the time remaining to the next existing alarm is determined to be less than twenty four hours and greater than or equal to one hour, the time remaining to the next existing alarm is displayed in increments of hours on the status bar of the display screen of the mobile device.

20. The apparatus of claim 15, wherein if the time remaining to the next existing alarm is determined to be less than an hour, the time remaining to the next existing alarm is displayed in increments of minutes on the status bar of the display screen of the mobile device.

21. The apparatus of claim 15, wherein if the mobile device changes to new time zone, the time remaining to each of the existing alarms of the one or more existing alarms is updated based on the new time zone.

22. The apparatus of claim 15 further comprising:
means for receiving a priority level for each existing alarm of the one or more existing alarms; and
means for determining a highest priority alarm of the one or more existing alarms.

23. The apparatus of claim 22, wherein the time remaining to the next existing alarm is the time remaining to the highest priority alarm of the one or more existing alarms.

24. The apparatus of claim 15 further comprising:
means for receiving one or more time zones corresponding to one or more alarm set time for the one or more existing alarms, wherein the setting the one or more existing alarms comprises setting the one or more existing alarms based on the one or more alarm set time and the one or more time zones.

25. The apparatus of claim 15, wherein the next existing alarm is a snooze alarm and the time remaining to the next existing alarm of the one or more existing alarms is the time remaining to a next snooze.

26. The apparatus of claim 15, further comprising:
means for receiving a snooze alarm;
means for determining a time remaining to the snooze alarm; and
means for displaying, on the status bar of the display screen, the determined time remaining to the snooze alarm in a first color different from a second color for displaying the determined time remaining to the next existing alarm.

27. The apparatus of claim 15, further comprising:
means for receiving an indication to turn on a stop watch or a timer of the mobile device;
means for determining an elapsed time of the stop watch or a time remaining of the timer, at the mobile device; and
the means for displaying at the status bar of the display screen of the mobile device, the determined elapsed time at the stop watch or the time remaining of the timer.

28. The apparatus of claim 15, further comprising:
means for receiving, an alarm set time for an alarm at the mobile device;
means for setting the alarm to the alarm set time.

29. An apparatus for providing an alarm indicator, comprising:
a memory; and
at least one processor coupled to the memory and configured to:
determine one or more existing alarms in a mobile device, and a corresponding alarm set time for each existing alarm of one or more existing alarms,
determine a time remaining to a next existing alarm of the one or more existing alarms; and
a display coupled to the at least one processor and configured to:
display on a status bar of a display screen of the mobile device, the determined time remaining to the next existing alarm.

30. The apparatus of claim 29, wherein the at least one processor is further configured to:
provide an alarm indication, when the time remaining to the next existing alarm is determined to be zero by the at least one processor; and
clear, the next existing alarm of the one or more existing alarms, after the alarm indication is provided for the next existing alarm.

31. The apparatus of claim 29, wherein the at least one processor determines the time remaining to the next existing alarm by calculating a time difference between a current time and the corresponding alarm set time of the next existing alarm.

32. The apparatus of claim 29, wherein if the time remaining to the next existing alarm is determined to be greater than twenty four hours, the time remaining to the next existing alarm is displayed in increments of days and/or fraction of days on the status bar of the display screen of the mobile device.

33. The apparatus of claim 29, wherein if the time remaining to the next existing alarm is determined to be less than twenty four hours and greater than or equal to one hour, the time remaining to the next existing alarm is displayed in increments of hours on the status bar of the display screen of the mobile device.

34. The apparatus of claim 29, wherein if the time remaining to the next existing alarm is determined to be less than an hour, the time remaining to the next existing alarm is displayed in increments of minutes on the status bar of the display screen of the mobile device.

35. The apparatus of claim 29, wherein if the mobile device changes to new time zone, the time remaining to each of the existing alarms of the one or more existing alarms is updated based on the new time zone.

36. The apparatus of claim 29, wherein the at least one processor is further configured to:
receive a priority level for each existing alarm of the one or more existing alarms; and
determine a highest priority alarm of the one or more existing alarms.

37. The apparatus of claim 36, wherein the time remaining to the next existing alarm is the time remaining to the highest priority alarm of the one or more existing alarms.

38. The apparatus of claim 29, wherein the at least one processor is further configured to:
receive one or more time zones corresponding to one or more alarm set time for the one or more existing alarms, wherein the setting the one or more existing alarms comprises setting the one or more existing alarms based on the one or more alarm set time and the one or more time zones.

39. The apparatus of claim 29, wherein the next existing alarm is a snooze alarm and the time remaining to the next existing alarm of the one or more existing alarms is the time remaining to a next snooze.

40. The apparatus of claim 29, wherein the at least one processor is further configured to:
receive a snooze alarm;
determine a time remaining to the snooze alarm; and
display, on the status bar of the display screen, the determined time remaining to the snooze alarm in a first color different from a second color for displaying the determined time remaining to the next existing alarm.

41. The apparatus of claim 29, wherein the at least one processor is further configured to:
receive an indication to turn on a stop watch or a timer of the mobile device;
determine an elapsed time of the stop watch or a time remaining of the timer, at the mobile device; and
display, on the status bar of the display screen of the mobile device, the determined elapsed time of the stop watch or the time remaining of the timer.

42. A computer-readable medium storing computer executable code, comprising code to:
determine one or more existing alarms in a mobile device, and a corresponding alarm set time for each existing alarm of one or more existing alarms;
determine a time remaining to a next existing alarm of the one or more existing alarms; and
display on a status bar of a display screen of the mobile device, the determined time remaining to the next existing alarm.
